(19) United States
(12) Patent Application Publication
(10) Pub. No.: US 2002/0162093 A1
(43) Pub. Date: Oct. 31, 2002

(54) Internationalization compiler and process for localizing server applications

(76) Inventors: Ming Zhou, Reading, MA (US); Bernhard J. Scholz, Ballston Lake, NY (US); Brian T. Murren, Clifton Park, NY (US); Richard B. Arthur, Ballston Spa, NY (US)

Correspondence Address: LEE & HAYES PLLC, SUITE 500, 421 W RIVERSIDE, SPOKANE, WA, 99201

(21) Appl. No.: 09/847,063

(22) Filed: Apr. 30, 2001

(51) Int. Cl. G06F 9/45

(52) U.S. Cl. 717/130; 717/141

(57) ABSTRACT

A compilation and translation system internationalizes an application authored for one locale for use in other locales. The system automatically extracts locale-sensitive content (e.g., language, regional information, slang, cultural aspects, etc.) from the source code and other locale-independent elements (e.g., formatting data). The extracted content can then be translated for use in the other locales. During runtime, requests from different locales can be served locale-sensitive responses by retrieving the source code and dynamically populating it with the appropriate content for the target locale.

### TECHNICAL FIELD

The present invention is directed to a system and method for localizing server applications written in one locale for use in one or more other locales.

### BACKGROUND

Computer software applications are traditionally developed by writing source code for components of the application, including a main module and various other modules, as well as functions or subroutines that are invoked by the modules. The source code is typically developed specifically for the domain of one computer application. Domains pertain to a particular category or area of service that the application provides. Example domains include asset management, leasing and lending, insurance, financial management, inventory tracking, resale and repair management, and so forth. Since the source code is developed specifically for each domain, the components of one computer application developed specifically for one domain might not be reusable for another computer application under development for another domain. Although some utility components (e.g., sort routines) can be reused by different computer applications, they are typically very low-level components that are not related to the domain of the computer application. Because of the inability to reuse high-level components for multiple computer applications across diverse domains, the cost of developing a computer application can be quite high. In addition, because the components are new, their reliability is often unproven.

Many techniques have been developed to facilitate the reusability and reliability of software components. One well-known technique is object-oriented programming. Object-oriented programming allows a programmer to define a type of component, known as an “object”. Each type of object has a defined interface with a defined behavior. A programmer can develop a computer application to use the interfaces of objects that have been developed by other programmers to provide that behavior within the computer application. The behavior of an object is provided by methods (or member functions), and the data of an object is provided as attributes (or data members). Although object-oriented programming techniques have helped increase the reusability and reliability software components, it is still very expensive to develop a computer application even using these reusable components. Part of the expense is attributable to the need of a computer programmer to know and understand all the interfaces of the components in order to integrate the components into the desired computer application.

These problems in developing computer applications are exacerbated by the increase in size and functionality of many modem large-scale server applications. Applications that once could be executed only by very expensive mainframe or supercomputers can now be executed by relatively inexpensive desktop or server computers (or groups thereof). Large-scale applications that are distributed across multiple server computers and support a large amount of functionality are becoming increasingly common. However, due to their size and complexity, these applications typically require large teams of software designers to design, build, and test the applications.

The complexity and large-scale nature of such applications also makes subsequent modifications to the applications difficult. For example, modifying a user interface to support a new computing platform or display language can be very time-consuming, as all user interface aspects of the application are sought out, modified, and tested by the system designers to accommodate the new features. Conversely, any modifications to the underlying problem-solving model implemented in the application can affect the manner in which information is displayed to the user. Such modifications add significant time to the application development as the system designers review and test the problem-solving model to ensure that the new (or remaining) features are operational with the user interface.

Large-scale web applications, which are accessible worldwide, are particularly susceptible to development delays caused by the need to make the applications functional for many different cultures, languages, and regions of the world. Currently, localizing applications for many different locales involves brute force replicating of multiple versions of the same application. These separate versions are either developed independently or the entire application is translated by a translation service. The translation process requires in depth knowledge of both natural languages and web presentation technologies, such as HTML and JSP. As a result it is neither cost efficient nor very reliable. This replicating approach is also expensive when updating the application, as multiple versions of each change are required.

It would thus be desirable to have a programming technique that reduces the time and expense it takes to internationalize an application written for one locale for use in other locales.

### SUMMARY

A compilation and translation system internationalizes an application authored for one locale for use in other locales. The system compiles documents (e.g., web pages, email forms, UI screens, etc.) authored for one locale by automatically extracting locale-sensitive content (e.g., language, regional information, slang, cultural aspects, etc.) into a separate data structure (e.g., a structured text file, database file, etc.). The source code and other locale-independent elements (e.g., formatting data) remain in the compiled document. The extracted content can then be translated for use in other locales. During runtime, requests from different locales can be served locale-sensitive responses by retrieving the compiled document and dynamically populating it with the appropriate content of the target locale.

### BRIEF DESCRIPTION OF THE DRAWINGS

FIG. 1 illustrates a network system that implements an exemplary server application.

FIG. 2 is a block diagram of an application architecture that allows the server application to be tailored to various domains.

FIG. 3 is a flowchart illustrating a general operation of the application architecture when handling client requests.

FIG. 4 is a block diagram of a compilation and translation system that takes application content authored for one locale and adapts that content for use in one or more other locales.

FIG. 5 is a flowchart of a process for adapting the content to multiple locales.

FIG. 6 illustrates a runtime mechanism that dynamically serves locale-specific content for a large-scale application with multinational users.

FIG. 7 is a flowchart of a process for dynamically producing locale-specific content.

The same reference numbers are used throughout the figures to reference like components and features.

### DETAILED DESCRIPTION

A compilation and translation system internationalizes applications for use in multiple locales. This internationalization is particularly beneficial for developers of large-scale applications, such as server-based web applications that are accessible worldwide, because it allows them to rapidly localize the application for each region of interest. The system takes application content authored for one locale and automatically converts that content for use in other locales, thereby extending the application's reach to multiple locales without the expense of rewriting the application for each of those locales.

The compilation and translation system separates locale-sensitive content from the source code and other locale-independent elements. The locale-sensitive content can then be translated for use in other locales. During runtime, requests from users in different locales can be served locale-sensitive responses by retrieving the source code and dynamically populating it with the appropriate content for the locale to which it will be served.

For discussion purposes, the system will be described with reference to a server application that is architected according to a multi-layer software architecture that specifies distinct layers or modules. The multi-layer architecture facilitates efficient and timely construction of business processes and server applications for many diverse domains. The architecture implements a common infrastructure and problem-solving logic model using a domain framework. By partitioning the software into a hierarchy of layers, individual modules may be readily “swapped out” and replaced by other modules that effectively adapt the architecture to different domains.

EXEMPLARY SYSTEM

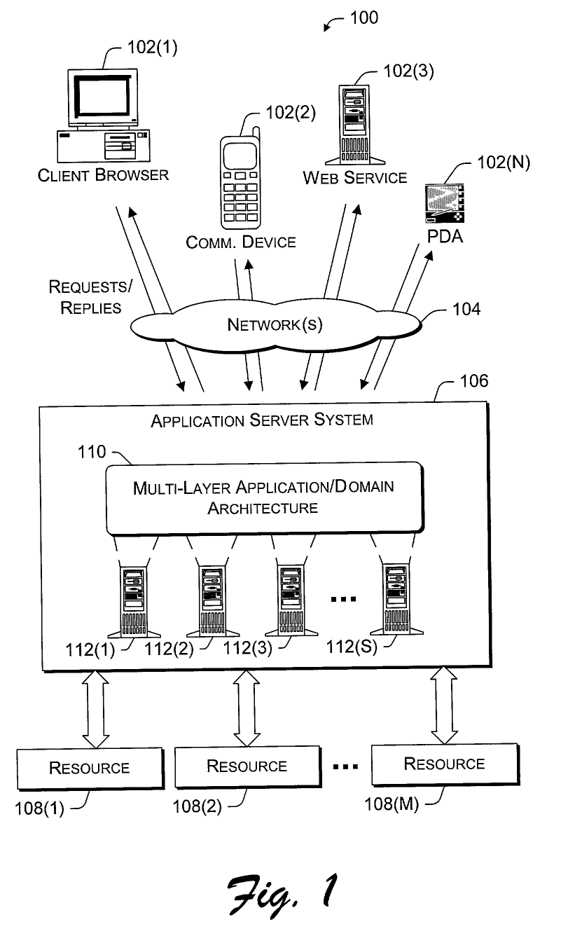

FIG. 1 shows a network system 100 in which the tiered software architecture may be implemented. The system 100 includes multiple clients 102(1), 102(2), 102(3), . . . , 102(N) that submit requests via one or more networks 104 to an application server system 106. Upon receiving the requests, the server system 106 processes the requests and returns replies to the clients 102 over the network(s) 104. In some situations, the server system 106 may access one or more resources 108(1), 108(2), . . . , 108(M) to assist in preparing the replies.

The clients 102 may be implemented in a number of ways, including as personal computers (e.g., desktop, laptop, palmtop, etc.), communications devices, personal digital assistants (PDAs), entertainment devices (e.g., Web-enabled televisions, gaming consoles, etc.), other servers, and so forth. The clients 102 submit their requests using a number of different formats and protocols, depending upon the type of client and the network 104 interfacing a client and the server 106.

The network 104 may be implemented by one or more different types of networks (e.g., Internet, local area network, wide area network, telephone, etc.), including wire-based technologies (e.g., telephone line, cable, etc.) and/or wireless technologies (e.g., RF, cellular, microwave, IR, wireless personal area network, etc.). The network 104 can be configured to support any number of different protocols, including HTTP (HyperText Transport Protocol), TCP/IP (Transmission Control Protocol/Internet Protocol), WAP (Wireless Application Protocol), and so on.

The server system 106 implements a multi-layer software architecture 110 that is tailored to various problem domains, such as asset management domains, financial domains, asset lending domains, insurance domains, and so forth. The multi-layer architecture 110 resides and executes on one or more computers, as represented by server computers 112(1), 112(2), 112(3), . . . 112(S). The tiered architecture 110 may be adapted to handle many different types of client devices 102, as well as new types as they become available. Additionally, the architecture 110 may be readily configured to accommodate new or different resources 108.

The server computers 112 are configured as general computing devices having processing units, one or more types of memory (e.g., RAM, ROM, disk, RAID storage, etc.), input and output devices, and a busing architecture to interconnect the components. As one possible implementation, the servers 112 may be interconnected via other internal networks to form clusters or a server farm, wherein different sets of servers support different layers or modules of the architecture 110. The servers may or may not reside within a similar location, with the software being distributed across the various machines. Various layers of the architecture 110 may be executed on one or more servers. As an alternative implementation, the architecture 110 may be implemented on single computer, such as a mainframe computer or a powerful server computer, rather than the multiple servers as illustrated.

The resources 108 are representative of any number of different types of resources. Examples of resources include databases, websites, legacy financial systems, electronic trading networks, auction sites, and so forth. The resources 108 may reside with the server system 106, or be located remotely. Access to the resources may be supported by any number of different technologies, networks, protocols, and the like.

Exemplary Application Architecture

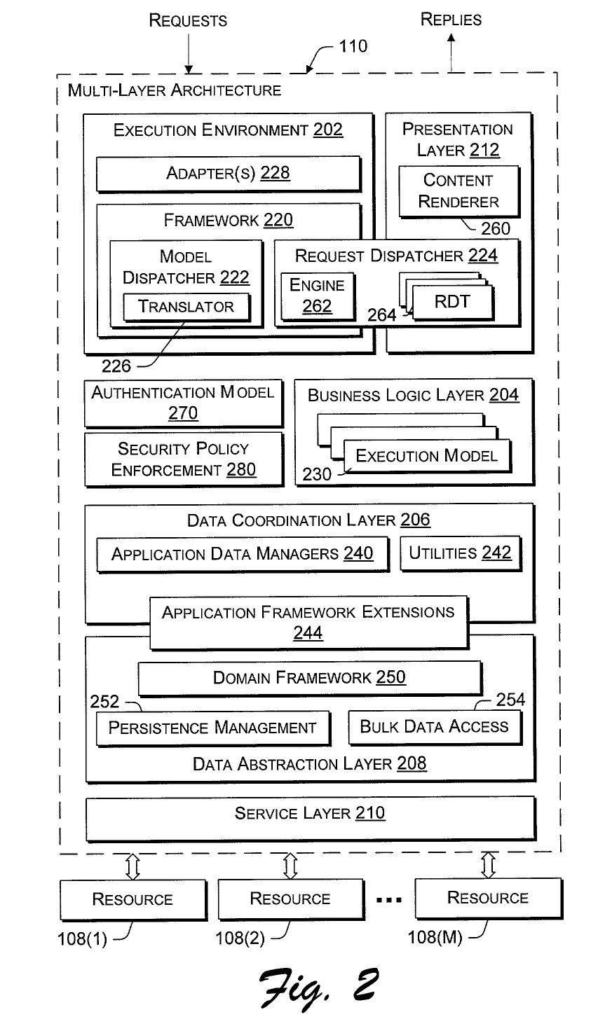

FIG. 2 illustrates one exemplary implementation of the multi-layer architecture 110 that is configured as a server application for a business-oriented domain. The architecture is logically partitioned into multiple layers to promote flexibility in adapting the architecture to different problem domains. Generally, the architecture 110 includes an execution environment layer 202, a business logic layer 204, a data coordination layer 206, a data abstraction layer 208, a service layer 210, and a presentation layer 212. The layers are illustrated vertically to convey an understanding as to how requests are received and handled by the various layers.

Client requests are received at the execution environment 202 and passed to the business logic layer 204 for processing according to the specific business application. As the business logic layer 204 desires information to fulfill the requests, the data coordination layer 206, data abstraction layer 208, and service layer 210 facilitate extraction of the information from the external resources 108. When a reply is completed, it is passed to the execution environment 202 and presentation layer 212 for serving back to the requesting client.

The architecture 110 can be readily modified to (1) implement different applications for different domains by plugging in the appropriate business logic in the business logic layer 204, (2) support different client devices by configuring suitable modules in the execution environment 202 and presentation layer 212, and (3) extract information from diverse resources by inserting the appropriate modules in the data abstraction layer 208 and service layer 210. The partitioned nature of the architecture allows these modifications to be made independently of one another. As a result, the architecture 110 can be adapted to many different domains by interchanging one or more modules in selected layers without having to reconstruct entire application solutions for those different domains.

The execution environment 202 contains an execution infrastructure to handle requests from clients. In one sense, the execution environment acts as a container into which the business logic layer 204 may be inserted. The execution environment 202 provides the interfacing between the client devices and the business logic layer 204 so that the business logic layer 204 need not understand how to communicate directly with the client devices.

The execution environment 202 includes a framework 220 that receives the client requests and routes the requests to the appropriate business logic for processing. After the business logic generates replies, the framework 220 interacts with the presentation layer 212 to prepare the replies for return to the clients in a format and protocol suitable for presentation on the clients.

The framework 220 is composed of a model dispatcher 222 and a request dispatcher 224. The model dispatcher 222 routes client requests to the appropriate business logic in the business logic layer 204. It may include a translator 226 to translate the requests into an appropriate form to be processed by the business logic. For instance, the translator 226 may extract data or other information from the requests and pass in this raw data to the business logic layer 204 for processing. The request dispatcher 224 formulates the replies in a way that can be sent and presented at the client. Notice that the request dispatcher is illustrated as bridging the execution environment 202 and the presentation layer 212 to convey the understanding that, in the described implementation, the execution environment and the presentation layer share in the tasks of structuring replies for return and presentation at the clients.

One or more adapters 228 may be included in the execution environment layer 202 to interface the framework 220 with various client types. As an example, one adapter may be provided to receive requests from a communications device using WAP, while another adapter may be configured to receive requests from a client browser using HTTP, while a third adapter is configured to receive requests from a messaging service using a messaging protocol.

The business logic layer 204 contains the business logic of an application that processes client requests. Generally speaking, the business logic layer contains problem-solving logic that produces solutions for a particular problem domain. In this example, the problem domain is a commerce-oriented problem domain (e.g., asset lending, asset management, insurance, etc.), although the architecture 110 can be implemented in non-business contexts. The logic in the logic layer is therefore application-specific and hence, is written on a per-application basis for a given domain.

In the illustrated implementation, the business logic in the business logic layer 204 is constructed as one or more execution models 230 that define how computer programs process the client requests received by the application. The execution models 230 may be constructed in a variety of ways. One exemplary execution model employs an interaction-based definition in which computer programs are individually defined by a series of one or more interaction definitions based on a request-response model. Each interaction definition includes one or more command definitions and view definitions. A command definition defines a command whose functionality may be represented by an object that has various attributes and that provides the behavior for that command. A view definition defines a view that provides a response to a request.

One example of an interaction-based model is a command bean model that employs multiple discrete program modules, called “Command Beans”, that are called for and executed. The command bean model is based on the “Java Bean” from Sun Microsystems, which utilizes discrete Java™ program modules. Other examples of an execution model include an action-view model and a use case model. The action-view model employs action handlers that execute code and provide a rendering to be served back to the client. The use case model maps requests to predefined UML (Unified Modeling Language) cases for processing.

The data coordination layer 206 provides an interface for the business logic layer 204 to communicate with a specific domain framework 250 implemented in the data abstraction layer 208 for a specific problem domain. In one implementation, the framework 250 utilizes a domain object model to model information flow for the problem domain. The data coordination layer 206 effectively partitions the business logic layer 204 from detailed knowledge of the domain object model as well as any understanding regarding how to obtain data from the external resources.

The data coordination layer 206 includes a set of one or more application data managers 240, utilities 242, and framework extensions 244. The application data managers 240 interface the particular domain object model in the data abstraction layer 208 into a particular application solution space of the business logic layer 204. Due to the partitioning, the execution models 230 in the business logic layer 204 are able to make calls to the application data managers 240 for specific information, without having any knowledge of the underlying domain or resources. The application data managers 240 obtain the information from the data abstraction layer 208 and return it to the execution models 230. The utilities 242 are a group of reusable, generic, and low-level code modules that developers may utilize to implement the interfaces or provide rudimentary tools for the application data managers 240.

The data abstraction layer 208 maps the domain object model to the various external resources 108. The data abstraction layer 208 contains the domain framework 250 for mapping the business logic to a specific problem domain, thereby partitioning the business applications and application managers from the underlying domain. In this manner, the domain framework 250 imposes no application-specific semantics, since it is abstracted from the application model. The domain framework 250 also does not dictate any functionality of services, as it can load any type of functionality (e.g., Java™ classes, databases, etc.) and be used to interface with third-party resources.

Extensions 244 to the domain framework 250 can be constructed to help interface the domain framework 250 to the application data managers 240. The extensions can be standardized for use across multiple different applications, and collected into a library. As such, the extensions may be pluggable and removable as desired. The extensions 244 may reside in either or both the data coordination layer 206 and the data abstraction layer 208, as represented by the block 244 straddling both layers.

The data abstraction layer 208 further includes a persistence management module 252 to manage data persistence in cooperation with the underlying data storage resources, and a bulk data access module 254 to facilitate access to data storage resources. Due to the partitioned nature of the architecture 110, the data abstraction layer 208 isolates the business logic layer 204 and the data coordination layer 206 from the underlying resources 108, allowing such mechanisms from the persistence management module 252 to be plugged into the architecture as desired to support a certain type of resource without alteration to the execution models 230 or application data managers 240.

A service layer 210 interfaces the data abstraction layer 208 and the resources 108. The service layer 210 contains service software modules for facilitating communication with specific underlying resources. Examples of service software modules include a logging service, a configuration service, a serialization service, a database service, and the like.

The presentation layer 212 contains the software elements that package and deliver the replies to the clients. It handles such tasks as choosing the content for a reply, selecting a data format, and determining a communication protocol. The presentation layer 212 also addresses the “look and feel” of the application by tailoring replies according to a brand and user-choice perspective. The presentation layer 212 is partitioned from the business logic layer 204 of the application. By separating presentation aspects from request processing, the architecture 110 enables the application to selectively render output based on the types of receiving devices without having to modify the logic source code at the business logic layer 204 for each new device. This allows a single application to provide output for many different receiving devices (e.g., web browsers, WAP devices, PDAs, etc.) and to adapt quickly to new devices that may be added in the future.

In this implementation, the presentation layer 212 is divided into two tiers: a presentation tier and a content rendering tier. The request dispatcher 224 implements the presentation tier. It selects an appropriate data type, encoding format, and protocol in which to output the content so that it can be carried over a network and rendered on the client. The request dispatcher 224 is composed of an engine 262, which resides at the framework 220 in the illustrated implementation, and multiple request dispatcher types (RDTs) 264 that accommodate many different data types, encoding formats, and protocols of the clients. Based on the client device, the engine 262 makes various decisions relating to presentation of content on the device. For example, the engine might select an appropriate data encoding format (e.g. HTML, XML, EDI, WML, etc.) for a particular client and an appropriate communication protocol (e.g. HTTP, Java™ RMI, CORBA, TCP/IP, etc.) to communicate the response to the client. The engine 262 might further decide how to construct the reply for visual appearance, such as selecting a particular layout, branding, skin, color scheme, or other customization based on the properties of the application or user preference. Based on these decisions, the engine 262 chooses one or more dispatcher types 264 to structure the reply.

A content renderer 260 forms the content rendering tier of the presentation layer 212. The renderer 260 performs any work related to outputting the content to the user. For example, it may construct the output display to accommodate an actual width of the user's display, elect to display text rather than graphics, choose a particular font, adjust the font size, determine whether the content is printable or how it should be printed, elect to present audio content rather than video content, and so on.

With the presentation layer 212 partitioned from the execution environment 202, the architecture 110 supports receiving requests in one format type and returning replies in another format type. For example, a user on a browser-based client (e.g., desktop or laptop computer) may submit a request via HTTP and the reply to that request may be returned to that user's PDA or wireless communications device using WAP. Additionally, by partitioning the presentation layer 212 from the business logic layer 204, the presentation functionality can be modified independently of the business logic to provide new or different ways to serve the content according to user preferences and client device capabilities.

The architecture 110 may include one or more other layers or modules. One example is an authentication model 270 that performs the tasks of authenticating clients and/or users prior to processing any requests. Another example is a security policy enforcement module 280 that supports the security of the application. The security enforcement module 280 can be implemented as one or more independent modules that plug into the application framework to enforce essentially any type of security rules. New application security rules can be implemented by simply plugging in a new system enforcement module 280 without modifying other layers of the architecture 110.

General Operation

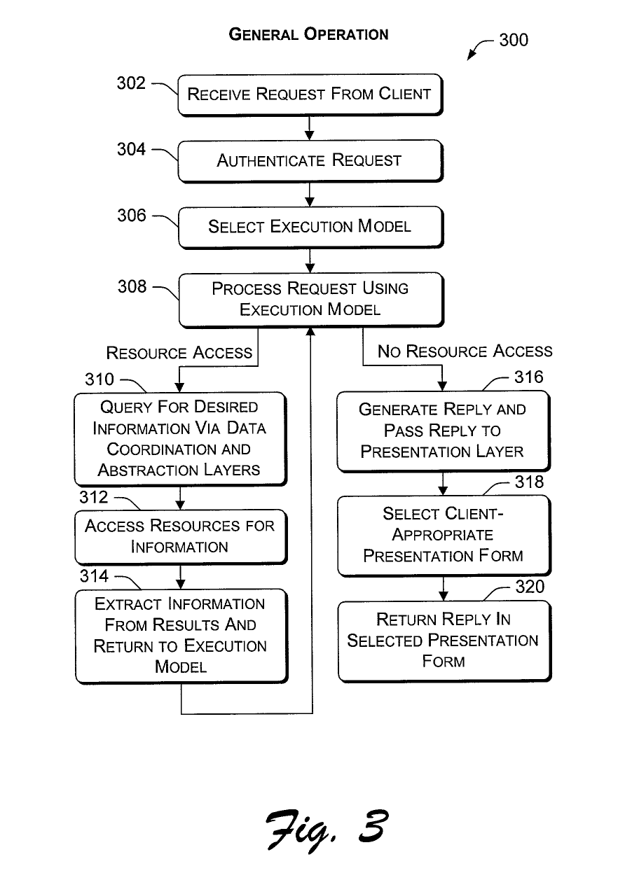

FIG. 3 shows an exemplary operation 300 of a business domain application constructed using the architecture 110 of FIGS. 1 and 2. The operation 300 is implemented as a software process of acts performed by execution of software instructions. Accordingly, the blocks illustrated in FIG. 3 represent computer-readable instructions, that when executed at the server system 106, perform the acts stipulated in the blocks.

To aid the discussion, the operation will be described in the context of asset management, wherein the architecture 110 is configured as a server application executing on the application server system 106 for an asset management domain. Additionally, for discussion purposes, suppose a user is equipped with a portable wireless communications device (e.g., a cellular phone) having a small screen with limited display capabilities and utilizing WAP to send/receive messages over a wireless cellular network. The user submits a request for information on a particular asset, such as the specification of a turbine engine or the availability of an electric pump, from the wireless communications device.

At block 302, requests from various clients are received at the execution environment layer 202. Depending on the client type, one or more adapters 228 may be involved to receive the requests and convert them to a form used internally by the application 110. In our example, the execution environment layer 202 receives the request from the wireless cellular network. An adapter 228 may be utilized to unwrap the request from its WAP-based packet for internal processing.

At block 304, the execution framework 202 may pass the request, or data extracted from the request, to the authentication model 270 for authentication of the client and/or user. If the requestor is not valid, the request is denied and a service denied message (or other type of message) is returned to the client. Assuming the request is valid, the authentication model 270 returns its approval.

At block 306, the model dispatcher 222 routes the request to one or more execution models 230 in the business logic layer 204 to process the client request. In our example, the model dispatcher 222 might select selects an execution model 230 to retrieve information on the particular asset. A translator 226 may be invoked to assist in conforming the request to a form that is acceptable to the selected execution model.

At block 308, the execution model 230 begins processing the request. Suppose, for example, that the selected execution model is implemented as a command bean model in which individual code sequences, or “command beans”, perform discrete tasks. One discrete task might be to initiate a database transaction, while another discrete task might be to load information pertaining to an item in the database, and a third discrete task might be to end the transaction and return the results.

The execution model 230 may or may not need to access information maintained at an external resource. For simple requests, such as an initial logon page, the execution model 230 can prepare a reply without querying the resources 108. This is represented by the “No Resource Access” branch in FIG. 3. For other requests, such as the example request for data on a particular asset, the execution model may utilize information stored at an external resource in its preparation of a reply. This is illustrated by the “Resource Access” branch.

When the execution model 230 reaches a point where it wishes to obtain information from an external resource (e.g., getting asset specific information from a database), the execution model calls an application data manager 240 in the data coordination layer 206 to query the desired information (i.e., block 310). The application data manager 240 communicates with the domain framework 250 in the data abstraction layer 208, which in turn maps the query to the appropriate resource and facilitates access to that resource via the service layer 210 (i.e., block 312). In our example, the domain framework is configured with an asset management domain object model that controls information flow to external resources—storage systems, inventory systems, etc.—that maintain asset information.

At block 314, results are returned from the resource and translated at the domain framework 250 back into a raw form that can be processed by the execution model 230. Continuing the asset management example, a database resource may return specification or availability data pertaining to the particular asset. This data may initially be in a format used by the database resource. The domain framework 250 extracts the raw data from the database-formatted results and passes that data back through the application data managers 240 to the execution model 230. In this manner, the execution model 230 need not understand how to communicate with the various types of resources directly, nor understand the formats employed by various resources.

At block 316, the execution model completes execution using the returned data to produce a reply to the client request. In our example, the command bean model generates a reply containing the specification or availability details pertaining to the requested asset. The execution model 230 passes the reply to the presentation layer 212 to be structured in a form that is suitable for the requesting client.

At block 318, the presentation layer 212 selects an appropriate format, data type, protocol, and so forth based on the capabilities of the client device, as well as user preferences. In the asset management example, the client device is a small wireless communication device that accepts WAP-based messages. Accordingly, the presentation layer 212 prepares a text reply that can be conveniently displayed on the small display and packages that reply in a format supported by WAP. At block 320, the presentation layer 212 transmits the reply back to the requesting client using the wireless network.

Internationalization of application

The architecture 110 is adaptable to many different cultures, languages, and regions of the world. This adaptability is particularly beneficial for developers of large-scale applications, such as server-based web applications that are accessible worldwide, because it allows them to rapidly localize the application for each region of interest.

To internationalize the architecture 110, developers employ a compilation and translation system that adapts locale-sensitive content to multiple other locales. Locale-sensitive content may include natural languages, regional dialects, slang, cultural customs, and so on. Generally, during an offline procedure, the system compiles documents (e.g., web pages, email forms, UI screens, etc.) authored for one locale. The compilation procedure extracts locale-sensitive content into a separate data structure, leaving the locale-independent source code and other elements in the compiled document. The extracted content can then be translated for use in many other locales. During runtime, requests from different locales can be served locale-sensitive responses by retrieving the compiled document and populating it with the appropriate content for the locale to which the document is being served.

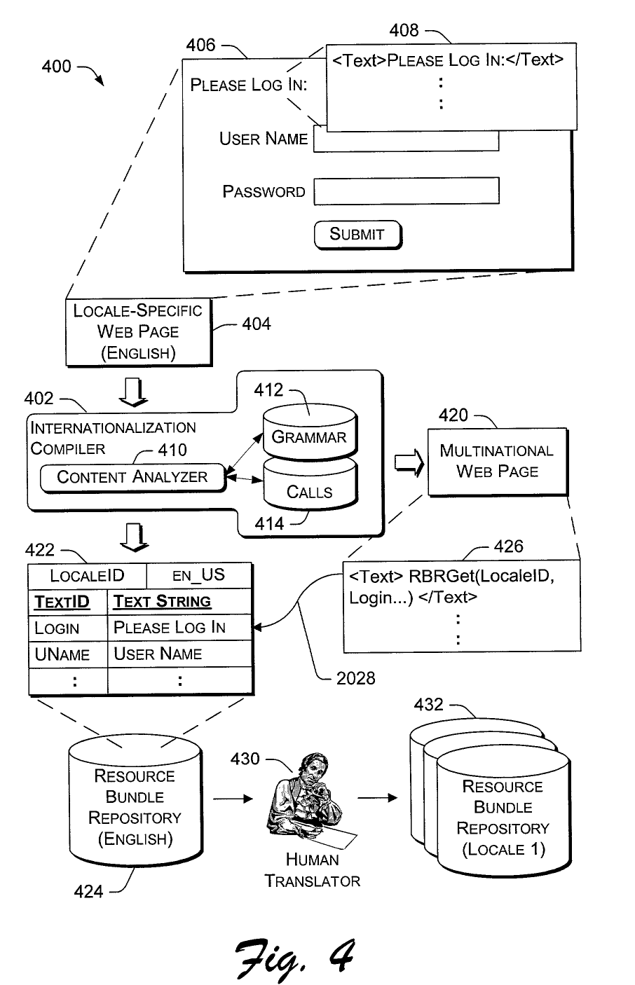

FIG. 4 illustrates the compilation and translation system 400 that adapts servable content (e.g., documents, forms, web pages, UI screens, etc.) from one locale to one or more other locales. The compilation and translation system 400 employs a tool, referred to as the “internationalization compiler” 402, which reads documents (e.g., web pages, email forms, UI screens, etc.) of an application authored for one locale and automatically converts those documents into a form that can be easily localized to any other locale through the translation process. The compiler 402 implements a set of rules that dictate how an input language (such as HTML, XML, WML, JSP, etc.) shall be localized. For example, an HTML rule defines which attribute value is localized (translated), and how the tag body, if defined, is localized (direct translation, treated as a script, etc.). The compiler 402 is equipped with a parser (or more generally, a content analyzer) to parse the language(s) for the application. As an example, for a J2EE based application, the parser is able to parse HTML content (including JavaScript) and JSP pages.

The internalization compiler 402 has a mechanism for extracting the locale-sensitive content, such as natural language text, from the documents. This extracted content is tagged with a unique identifier, which can be used to later access the content. This identifier is inserted into the “compiled” document in place of the corresponding content, thereby creating a locale-independent document shell or core that contains locale-independent source code.

In the example illustrated in FIG. 4, suppose the document is a web page 404 that is created for a specific locale, which utilizes English. When served and rendered, the web page 404 forms a logon screen 406 with English text. The logon screen 406 contains an English textual greeting “Please Log In:”, an English textual element “User Name”, a first entry field to accept alphabet character strings for the user's name, an English textual element “Password”, and a second entry field to accept alphanumeric strings for the user's password. The logon screen 406 also includes an actuatable “Submit” button.

For discussion purposes, suppose the web page 404 is written in HTML. An excerpt of the HTML code for the login greeting is illustrated within a hovering box 408. The login greeting is a textual element as delimited by the text tags “<Text>, </Text>”. The entire HTML source code for the visible elements of screen 406 is presented below.

<Form>

<Text>Please Log In:</Text>

<input type=“text” name=“User Name” required=“true” maxlength=“32”>

<input type=“password” name=“Password” required=“true” minlength=“5”>

<input type=“submit” value=“Submit”>

</Form>

The locale-specific web page 404 is submitted to the internationalization compiler 402 for conversion to a locale-independent data structure. In the described implementation, the compiler 402 extracts the locale-specific elements (e.g., language text, etc.) into a resource bundle and replaces the extracted elements in the web page with function calls to the resource bundle.

The compiler 402 includes a content analyzer 410, a grammar 412, and a call library 414. The content analyzer 410 analyzes each line of code in the locale-specific document (e.g., web page 404) and identifies locale-specific elements. The content analyzer 410 utilizes grammar 412 to distinguish which elements are locale-specific by understanding the structure and form of the code. A grammar 412 that specifies HTML, for example, aids the content analyzer 410 in discerning which HTML tags contain text so that these tags can be flagged as containing character strings of a natural language that should be translated to another language. The content analyzer 410 replaces the locale-specific elements with appropriate function calls retrieved from the call library 414, or other types of references.

The content analyzer 410 outputs a compiled data structure that is locale independent, as represented by the multinational web page 420. The compiled data structure contains source code and locale-independent elements, but all natural languages or other locale-dependent content has been removed. The analyzer 410 stores the extracted locale-specific content in a resource bundle 422, which in turn is collected or stored in a repository 424. In one implementation, the resource bundle 422 is constructed as a structured text file (e.g., property file), although other file types may be used (e.g., database file, etc.).

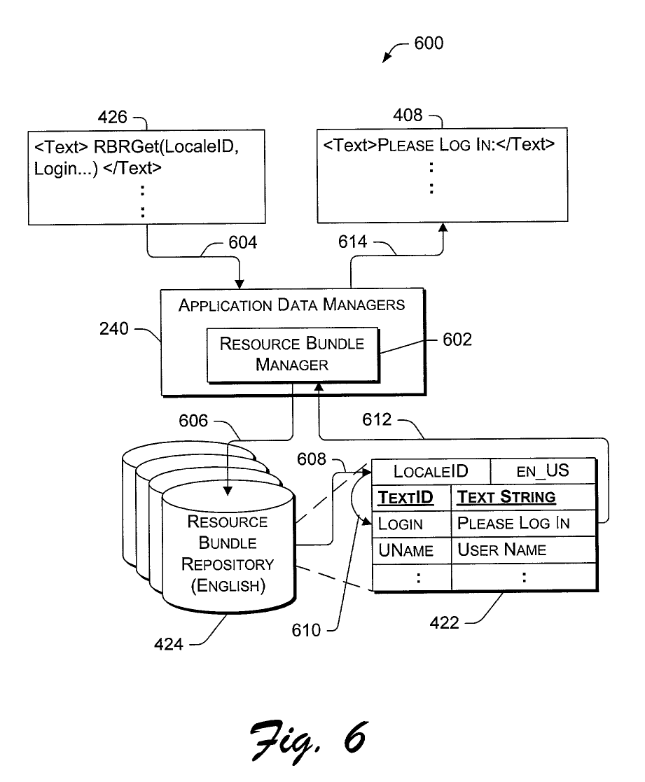

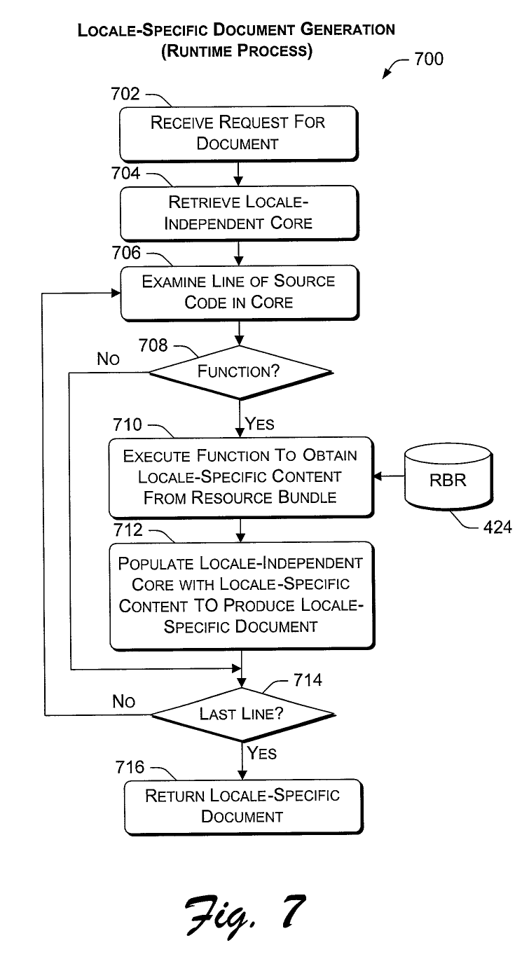

In the illustrated example of FIG. 4, the compiled web page 420 contains tags and code elements of the original source code, as well as other locale-independent elements. The locale-specific content is replaced with the function calls to the appropriate resource bundle 422. Notice that the HTML code 426 for the multinational web page 420 contains the same tags “<Text>, </Text>”, but the English text is replaced with a function call “RBRGet”. The function call has a set of parameters, including a locale identifier (e.g., “en_US”) to identify the corresponding resource bundle and a text string identifier (e.g., “Login”) to identify a desired text phrase to insert into the web page at runtime. When the web page 420 is executed for a given locale, the function call is invoked to access the appropriate resource bundle 422 to obtain the proper login greeting for that locale (as represented by reference arrow 428). The runtime generation of a locale-specific web page 420 is described below in more detail with reference to FIGS. 6 and 7.

The entire HTML source code for the compiled document core used to produce screen 406 might appear like the following:

<Form>

<Text>RBRGet(LocaleID, Login, . . . )</Text>

<input type=“text” name=“RBRGet(LocaleID, Uname, . . . )” required=“true” maxlength=“32”>

<input type=“password” name=“RBRGet(LocaleID, PW, . . . )” required=“true” minlength=“5”>

<input type=“submit” value=“Submit”>

</Form>

The locale-specific content extracted from the logon screen and stored in resource bundle 422 includes such elements as the English text strings “Please Log In”, “User Name”, and “Password”. The resource bundle 422 is depicted as a tabular data structure with fields containing locale-specific content. A locale identifier “LocaleID” is set to a version of English named “en_US” to represent that the resource bundle contains elements for a locale that uses the version of English spoken and written in the United States, as opposed to the version of English spoken and written in the United Kingdom, or elsewhere.

To produce the same content for other locales, the resource bundle is translated by a human translator 430 into the languages of the other locales. It is noted that automatic translation systems may be employed in addition to, or in place of, the human translators.

The translation process produces multiple resource bundles 432 for different locales. Each resource bundle retains, however, the same identifiers so that the compiled document can locate the desired content during runtime. For example, the text identifier “Login” remains the same in the various resource bundles, even though the associated text string “Please Log In” might be translated into various languages. Each resource bundle is identified by the locale identity “LocaleID”.

Notice that by separating the content from the source code, the human translator 430 only translates words and phrases, and does not need to understand the underlying source code such as HTML, XML, WML, and so on. The locale-independent core can be reused for different locales and languages. It does not need to be translated. When the core is processed, it simply pulls in content from various resource bundle repositories 424 and 432 to produce the content for associated locales.

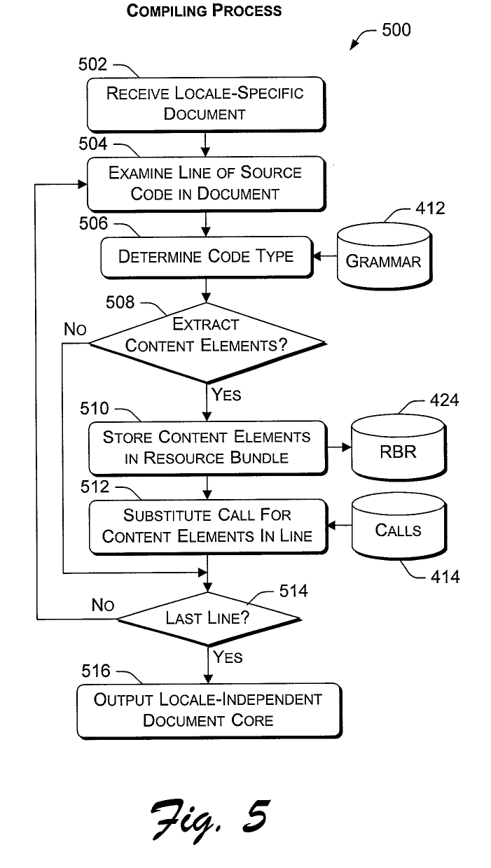

FIG. 5 shows a process 500 for internationalizing content delivered by large-scale applications. The process 500 is implemented as a software process performed by execution of software instructions and hence, the blocks illustrated in FIG. 5 recite acts performed when the computer-readable instructions are executed.

At block 502, the compiler 402 receives a locale-specific document, such as the HTML-based logon screen 406 illustrated in FIG. 4. The compiler 402 examines the source code in the document, line by line (i.e., block 504). The compiler 402 utilizes one or more grammars 412 to determine the code type and whether such code type may have elements that are locale-specific (i.e., block 506). For instance, the compiler 402 can use a grammar versed in HTML to identify text tags “<Text>, </Text>”, while understanding that the content between the tags is locale specific and should be extracted.

At block 508, the compiler 402 decides whether to extract any locale-specific content elements from the source code line. This decision is based in part on the code type. If no such elements exist (i.e., the “no” branch from block 508), the compiler continues to the next line of code. On the other hand, if locale-specific content elements exist (i.e., the “yes” branch from block 508), the compiler extracts and stores the content elements in a resource bundle repository (RBR) 424 (i.e., block 510). The compiler then substitutes a function call from the call library 414 for the content elements in the source code line (i.e., block 512). The compiler 402 continues, line-by-line, until the last line in the document is reached, as indicated by the decision block 514.

Once the compiler has evaluated the entire document, it outputs the compiled document core with locale-independent source code and function calls substituted for locale-specific elements (i.e., block 516). The resource bundle collected throughout the process is stored in repository 424. After the resource bundle is created for a given locale, the resource bundle is translated into many different languages for many diverse locales, preserving the identifiers for each piece of translatable content. The resource bundle primarily includes the natural language content without any application code or formatting instructions (e.g., HTML and or JSP code). This makes translation easier and less error prone.

These resource bundles are accessible at runtime by the server application 110 to conform replies to the appropriate locales of the users. The server application implements a resource bundle manager to manage access to the various resource bundles. Given a locale identifier to locate the resource bundle and a content identity to find the locale-specific content within that bundle, the application can dynamically populate the compiled document with the content from the corresponding resource bundle at runtime.

FIG. 6 shows a runtime system 600 that serves the appropriate content for a user's locale. The system 600 includes a resource bundle manager 602 that converts the locale-independent compiled document back into any appropriate locale-specific document by retrieving the correct locale-specific content from one of the resource bundles. The resource bundle manager 602 is illustrated as being implemented as one of the application data managers 240 of the data coordination layer 206. However, it may reside in other layers of the multi-layer architecture 110 or external to the architecture. The resource bundle manager 602 manages access to one or more resource bundle repositories 2024.

To illustrate the functionality of the resource bundle manager 602, suppose that a user who is attempting to logon to the server application resides in a locale that speaks a United States version of English. The logic layer 204 (FIG. 2) receives the request and prepares to return a reply in the form of a login screen 406 (FIG. 4). The logic layer 204 submits the identity of the locale and transfers control to the resource bundle manager 602 of the resource coordination layer to obtain the appropriate login screen for that locale.

The resource bundle manager 602 takes the locale-independent document 426 produced by the internationalization compiler 402 and executes the function calls in the source code (i.e., flow path 604). In the illustrated example, the resource bundle manager 602 executes the “RBRGet” function call, passing in parameters including a locale identity of “en_US” and a text identity of “Login”. The resource bundle manager 602 uses the locale identity parameter to access the appropriate resource bundle repository that contains the resource bundle 422 for “localeID=en_US” (i.e., flow paths 606 and 608). At this point, the text identity is used to index to the appropriate text string for “textID=Login” (i.e., flow path 610). The English text string “Please Log In” is returned to the resource bundle manager 602 (i.e., flow path 612) and inserted into the document core, thereby producing the locale-specific document 408 (i.e., flow path 614).

FIG. 7 shows a process 700 for producing at runtime locale-specific content delivered by large-scale applications. The process 700 is implemented in software as computer-executable instructions that, when executed, perform the acts recited in the blocks of FIG. 7.

At block 702, the resource bundle manager 602 receives a request to produce a document (e.g., web document, email form, etc.) for a given locale. The request contains the identity of the locale (i.e., LocaleID) to specify the intended resource bundle and an identity of content (e.g., TextID) to identify the locale-specific content within the resource bundle.

At block 704, the resource bundle manager 602 obtains the locale-independent document core associated with the desired document. The resource bundle manager 602 examines each line of source code in the document core (i.e., block 706). If no function is found (i.e., the “no” branch from block 708), the resource bundle manager continues to the next line of code.

When a function call is found in the source code (i.e., the “yes” branch from block 708), the resource bundle manager 602 executes the function call to access the appropriate resource bundle for the passed in locale identity and obtain the content specified by the content identity (i.e., block 710). At block 712, the resource bundle manager 602 populates the locale-independent document core with locale-specific content to produce the desired document. The resource bundle manager 602 continues, line-by-line, until the last line in the document is reached, as indicated by the decision block 714. After all source code in the document core is examined (i.e., the “yes” branch from block 714), the resource bundle manager 602 returns the populated document to the logic layer for further processing, or to the presentation layer for presentation to the requesting client device (i.e., block 716).

The compilation and translation process is beneficial in that it allows developers to develop an application in one language/country, and localize it for deployment anywhere in the world with minimum effort. The automatic extraction process employed by the compiler significantly reduces the time for bringing a new application to the world market. Also, by extracting out the natural language content, the translation process is simplified. The translators can concentrate exclusively on translating pure language content. No translation effort is required for any programming code or formatting instructions, making the translation phase more efficient and less error-prone. Furthermore, the translators do not even need to see the application since application development and translation are separate processes. This separation helps protects the proprietary information in the application.

For any future updates of the application, developers simply have to re-compile the locale-independent document cores. Any new content is appended to the existing resource bundle, making it is easy to find the new additions and have only those changes translated for other supported locales. In other words, only content that has been modified or added since the last compilation is translated, significantly reducing the cost and effort. Application development cost can be further reduced by sharing translation resource bundles across multiple applications.

### CONCLUSION

The discussions herein are directed primarily to software modules and components. Alternatively, the systems and processes described herein can be implemented in other manners, such as firmware or hardware, or combinations of software, firmware, and hardware. By way of example, one or more Application Specific Integrated Circuits (ASICs) or Programmable Logic Devices (PLDs) could be configured to implement selected components or modules discussed herein.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A computer-implemented method comprising:
analyzing a computer-servable document written for a particular locale; and
extracting locale-sensitive content from the document while leaving locale-independent elements in the document.

2. A computer-implemented method as recited in claim 1, wherein the analyzing comprises examining each line of code in the document and based on the code, identifying the locale-sensitive content.

3. A computer-implemented method as recited in claim 1, wherein the locale-sensitive content comprises natural language text.

4. A computer-implemented method as recited in claim 1, wherein the locale-independent elements comprise source code and formatting data.

5. A computer-implemented method as recited in claim 1, further comprising storing the locale-sensitive content in a data structure separate from the document.

6. A computer-implemented method as recited in claim 5, further comprising substituting a function call in place of associated locale-sensitive content in the document, the function call being configured such that, when executed, the function call obtains the locale-sensitive content from the data structure.

7. A method comprising:
examining source code in a document written for a particular locale;
determining, from the source code, locale-sensitive content that is specific to the particular locale;
extracting the locale-sensitive content from the source code;
storing the locale-sensitive content in a separate file; and
inserting, into the document in place of the locale-sensitive content, a reference to the locale-sensitive content in the separate file.

8. A method as recited in claim 7, wherein the locale-sensitive content comprises natural language text.

9. A method as recited in claim 7, wherein the determining comprises:
ascertaining a type of code elements using a grammar for the source code; and
identifying, based on the type of the code elements, any locale-sensitive content delimited by the code elements.

10. A method as recited in claim 7, wherein the storing comprises storing the locale sensitive content in a structured text file.

11. A method as recited in claim 7, wherein the storing comprises storing the locale sensitive content in a database file.

12. A method as recited in claim 7, wherein the reference comprises a function call that, when executed, obtains the locale-sensitive content from the separate file.

13. A method comprising:
automatically compiling a computer-servable document written for a particular locale to extract any locale-sensitive content, the compiling producing a compiled document with locale-independent elements; and
storing the locale-sensitive content in a form that can be translated to other locales.

14. A method as recited in claim 13, wherein the locale-sensitive content comprises natural language text.

15. A method as recited in claim 13, wherein the locale-independent elements comprise source code and formatting data.

16. A method as recited in claim 13, further comprising substituting a reference in place of the locale-sensitive content in the compiled document, the reference identifying the locale-sensitive content extracted form the compiled document.

17. A method as recited in claim 13, further comprising substituting a function call in place of the locale-sensitive content in the compiled document, the function call being configured such that, when executed, the function call obtains and embeds the locale-sensitive content back into the compiled document.

18. A method as recited in claim 13, further comprising retrieving, at runtime, the compiled document and populating the compiled document with the locale-sensitive content to reconstruct the computer-servable document that can be served to the particular locale.

19. A method as recited in claim 13, wherein the locale-sensitive content is translated in to a second version for use in a second locale, further comprising retrieving, at runtime, the compiled document and populating the compiled document with the second version of the locale-sensitive content to construct a computer-servable document that can be served to the second locale.

20. A method comprising:
compiling a computer-servable document written for a particular locale to extract any locale-sensitive content, the compiling producing a compiled document with locale-independent elements;
storing the locale-sensitive content; and
at runtime, retrieving the compiled document and populating the compiled document with the locale-sensitive content.

21. A method as recited in claim 20, wherein the locale-sensitive content comprises natural language text.

22. A method as recited in claim 20, wherein the locale-independent elements comprise source code and formatting data.

23. A method as recited in claim 20, wherein the storing comprises storing the locale-sensitive content in a structured text file.

24. A method as recited in claim 20, wherein the storing comprises storing the locale sensitive content in a database file.

25. A method as recited in claim 20, further comprising:
substituting a function call in place of associated locale-sensitive content in the compiled document; and
the populating comprises executing the function call in the compiled document to obtain the associated locale-sensitive content and insert the associated locale-sensitive content back into the compiled document.

26. A method as recited in claim 20, further comprising:
storing one or more translated versions of the locale-sensitive content; and
at runtime, retrieving the compiled document and populating the compiled document with a translated version of the locale-sensitive content.

27. A method for producing a document to be served to a user in a particular locale, comprising:
retrieving a locale-independent core that contains locale-independent elements; and
populating the locale-independent core with locale-sensitive content that is appropriate for the particular locale.

28. A method as recited in claim 27, wherein the locale-sensitive content comprises natural language text.

29. A method as recited in claim 27, wherein the locale-independent elements comprise source code and formatting data.

30. A method as recited in claim 27, wherein the locale-independent core contains a function call in place of where corresponding locale-sensitive content reside in the document, and the populating comprises executing the function call to obtain the locale-sensitive content and insert the locale-sensitive content into the core.

31. A method as recited in claim 27, wherein multiple translations of the locale-sensitive content exist for multiple locales, and further comprising populating the locale-independent core with a translation of the locale-sensitive content, the translation being suitable for a corresponding locale to which the document is to be served.

32. A system comprising:
at least one computer-servable document stored in a computer-readable medium, the document being written for a particular locale; and
a compiler to automatically extract locale-sensitive content from the document to produce a compiled document containing locale-independent elements.

33. A system as recited in claim 32, wherein the locale-sensitive content comprises natural language text.

34. A system as recited in claim 32, wherein the locale-independent elements comprise source code and formatting data.

35. A system as recited in claim 32, wherein the compiler examines source code in the document to determine, from the source code, whether locale-sensitive content is present.

36. A system as recited in claim 32, wherein the compiler stores the locale-sensitive content in a data structure separate from the compiled document.

37. A system as recited in claim 36, wherein the compiler inserts a reference in place of the locale-sensitive content in the document, the reference identifying the locale-sensitive content in the data structure.

38. A system as recited in claim 36, wherein the compiler substitutes a function call in place of associated locale-sensitive content in the compiled document, the function call being configured such that, when executed, the function call obtains the associated locale-sensitive content from the data structure and inserts the associated locale-sensitive content back into the compiled document.

39. A system as recited in claim 32, further comprising a runtime manager that, prior to serving, populates the compiled document with the locale-sensitive content.

40. A system as recited in claim 32, wherein the locale-sensitive content is translated into at least one translated version of the content, further comprising a runtime manager that populates the document with the translated version of the content.

41. A compiler system comprising:
a grammar containing rules for structuring source code;
a content analyzer to analyze source code in a document written for a particular locale and to utilize the grammar to determine whether the source code contains locale-sensitive content that is specific to the particular locale, the content analyzer being configured to replace the locale-sensitive content in the source code with associated references to the replaced locale-sensitive content.

42. A compiler system as recited in claim 41, wherein the locale-sensitive content is placed in a separate file, and the references comprise a pointer to that file.

43. A compiler system as recited in claim 41, wherein the locale-sensitive content is placed in a separate data structure, and the references comprise function calls that, when executed, obtain the associated locale-sensitive content from the data structure and insert the associated locale-sensitive content into the source code.

44. A compiler system as recited in claim 41, further comprising:
a call library to store function calls; and
the content analyzer replaces the locale-sensitive content with one or more function calls from the call library, the function calls being configured such that, when executed, the function calls reinsert the locale-sensitive content back into the source code.

45. A system comprising:
a resource bundle containing locale-specific content that is authored for a particular locale; and
a resource bundle manager to populate a locale-independent document core with the locale-sensitive content in the resource bundle to produce a computer-servable document that is suitable to be served to the particular locale.

46. A system as recited in claim 45, wherein the resource bundle is embodied as one of a structured text file or a database file.

47. A system as recited in claim 45, wherein the locale-specific content comprises natural language text.

48. A system as recited in claim 45, wherein the document core contains source code and function calls embedded within the source code, the resource bundle manager being configured to execute the function calls to reinsert associated locale-specific content into the document core.

49. A system comprising:
compilation means for compiling a computer-servable document written for a particular locale to extract any locale-sensitive content, the compilation means producing a compiled document with locale-independent elements; and
storage means for storing the locale-sensitive content extracted from the computer-servable document in a data structure separate from the compiled document.

50. A system as recited in claim 49, wherein the compilation means comprises substitution means for substituting a reference in place of the locale-sensitive content in the compiled document, the reference identifying the locale-sensitive content extracted form the compiled document.

51. A system as recited in claim 49, further comprising runtime means for populating, at runtime, the compiled document with the locale-sensitive content to reconstruct the computer-servable document.

52. A system as recited in claim 49, wherein the locale-sensitive content is translated in to a second version for use in a second locale, further comprising runtime means for populating, at runtime, the compiled document with the second version of the locale-sensitive content to construct a computer-servable document that can be served to the second locale.

53. A system comprising:
retrieval means for retrieving a document core containing locale-independent elements; and
populating means for populating the document with locale-sensitive content to produce a computer-servable document that is appropriate for serving to a particular locale.

54. A system as recited in claim 53, wherein multiple translations of the locale-sensitive content exist for multiple locales, the populating means comprises populating the document core with a translation of the locale-sensitive content to produce a computer-servable document that is suitable for serving into another locale.

55. One or more computer-readable media comprising computer-executable instructions that, when executed, direct a computer to:
examine source code in a document written for a particular locale;
extract any locale-sensitive content from the source code;
store the locale-sensitive content in a separate file; and
substitute, in place of the locale-sensitive content in the document, a reference to the locale-sensitive content in the separate file.

56. One or more computer-readable media comprising computer-executable instructions that, when executed, direct a computer to:
retrieve a core file containing source code and locale-independent elements; and
populate the core file with locale-sensitive content that is appropriate for a particular locale to produce a document that can be served to the particular locale.
